(19) United States
(12) Patent Application Publication
(10) Pub. No.: US 2025/0074534 A1
(43) Pub. Date: Mar. 6, 2025

(54) Kind of Motorbike Frame

(71) Applicant: Wuhu Fourstar Sports Share Co.,Ltd, Anhui (CN)

(72) Inventor: Xiaowei Li, Anhui (CN)

(73) Assignee: Wuhu Fourstar Sports Share Co.,Ltd, Anhui (CN)

(21) Appl. No.: 18/457,321

(22) Filed: Aug. 28, 2023

(51) Int. Cl. B62K 11/04; B62K 19/06

(52) U.S. Cl. CPC B62K 11/04; B62K 19/06

(57) ABSTRACT

Embodiments of the present disclosure may include a frame characterized in that it may include frame head tube, main frame assembly, sub-frame components, and support assembly. In some embodiments, the main frame assembly may include first main frame and second main frame disposed diagonally opposite each other, the first main frame and the second main frame both being of a bent structure and having their ends attached to the same side of the frame head tube and forming a closed loop with the frame head tube. The distance between the rear ends of the first main frame and the second main frame may be greater than the distance between the front ends so as to form a space for the installation of the engine between first main frame and second main frame.

### TECHNICAL FIELD

The present invention relates to the field of motorbikes, and in particular to a kind of motorbike frame.

### BACKGROUND

Motorbikes are mainly used as road transportation tools in cities and mountainous areas, and in addition to carrying drivers, they may also carry passengers or goods, therefore, they need higher reliability and safety. The frame, as the main load-bearing carrier of the motorbike, has to bear a large weight on the one hand, and on the other hand, it has to withstand the vibration caused by road bumps, so the strength and rigidity of the motorbike frame are very important.

In addition, with the increasing demand of consumers, motorbikes not only need to have a good carrying capacity, but also need to have a unique personality and appearance, and the frame, as the main support structure of the motorbike, determines the appearance of the motorbike to a large extent. Therefore, the motorbike frame also needs to have a better modelling structure.

### SUMMARY

Embodiments of the present disclosure may include a frame characterized in that it may include frame head tube, main frame assembly, sub-frame components, and support assembly. In some embodiments, the main frame assembly may include first main frame and second main frame disposed diagonally opposite each other, the first main frame and the second main frame both being of a bent structure and having their ends attached to the same side of the frame head tube and forming a closed loop with the frame head tube. The distance between the rear ends of the first main frame and the second main frame may be greater than the distance between the front ends so as to form a space for the installation of the engine between first main frame and second main frame.

In some embodiments, the sub-frame components may include oppositely disposed first sub-frame and second sub-frame, the first sub-frame and second sub-frame both being of a bent structure, and the first sub-frame being connected diagonally to a lower portion of the rear side of the first main frame at each end, and the second sub-frame being connected diagonally to a lower portion of the rear side of the second main frame at each front and rear end, so as to form a space for mounting the brake between first sub-frame and second sub-frame. In some embodiments, the support assembly may include support frame, the support frame being of a bent structure, the ends of the support frame being attached diagonally from below to an upper portion of the rear side of the first main frame and the second main frame, respectively, so as to form a recessed area for mounting a cushion between the upper ends of first main frame and second main frame and the upper end of support frame.

Embodiments may also include a frame according to, characterized in that the frame head tube may be made of a hollow metal tubular member with steering limit seat mounted at the bottom to limit the steering angle of frame head tube. In some embodiments, the frame according to, characterized in that the first main frame and the second main frame may be made of hollow metal tubing, which may be low cost and easy to process, and both have the same shape and dimensions in a generally trapezoidal shape, with an arc at the upper end, which allows for the formation of a larger space for mounting the engine under a limited perimeter between the first main frame and the second main frame, and has a smooth and beautiful profile.

Embodiments may also include a frame according to, characterized in that the first main frame and the second main frame may also be rectangular, or triangular, or circular, or sector, or irregular polygonal. In some embodiments, the frame according to, characterized in that the first sub-frame and the second sub-frame may be made of hollow metal tubing, which may be low cost and easy to process, and both have the same shape and dimensions in a U-shape.

Embodiments may also include a frame according to, characterized in that the first sub-frame and the second sub-frame may also be semi-circular. Embodiments may also include a frame according to, characterized in that the first sub-frame and the second sub-frame may be further mounted on the inside of the brake mount and first decorative plate mount, by means of which the brake may be mounted and positioned, and by means of which first decorative plate mount facilitates the fixed mounting of a decorative plate.

Embodiments may also include a frame according to, characterized in that the support frame forms an angular connection between the first main frame and the second main frame, respectively, in an angular range of between 145-175°, which angular range may be the recessed area where the cushion may be mounted. Embodiments may also include a frame according to, characterized in that the support frame forms an angular connection between the first main frame and the second main frame, respectively, in an angular range of between 155-165°, which angular range may be the recessed area where the cushion may be mounted.

Embodiments may also include a frame according to, characterized in that the support frame may be made of hollow metal tubing in the shape of a U, which may be low cost and easy to process. Embodiments may also include a frame according to, characterized in that the support frame may also be semi-circular. Embodiments may also include a frame according to, characterized in that the main frame assembly may include main frame assembly, engine mounting plate and footrest connecting tube, the main frame assembly being connected between the rear end of the first main frame and the lower part of the second main frame, the footrest connecting tube being connected at the front end of the first main frame and the lower part of the second main frame and extending at both ends to the outside of the first main frame and the second main frame, respectively, and the engine mounting plate being connected between the main frame assembly and the footrest connecting tube, with a welded fixing connection for a firm connection, by means of which the engine may be mounted and positioned, and by means of which the late may be used to mount the plate.

Embodiments may also include a frame according to, characterized in that the footrest connecting tube may be made of hollow metal tubing, each end of which may be connected to footrest mount in a slotted structure so as to allow the mounting of a footplate through footrest mount. Embodiments may also include a frame according to, characterized in that the main frame assembly may include two first support strips and a second trim plate mount mounted on the first support strips, the two first support strips being provided opposite to each other, and one end of the first support strips being connected to the inner top of the first main frame or the second main frame respectively, and the other end being connected to the inner side portion of the first main frame or the second main frame respectively, in order to increase the structural strength of the (first main frame and second main frame) and to achieve a reduction of vibration, and at the same time to facilitate the fixing and mounting of a decorative plate by means of the second trim plate mount.

Embodiments may also include a frame according to, characterized in that the first support strips may be made of hollow metal tubing in the form of a curved or diagonal shape. Embodiments may also include a frame according to, characterized in that the support assembly may include two second support bar and an fender mount mounted on the second support bar, the two second support bar being set opposite to each other, and one end of each of the second support bar being connected to the support frame, and the other end being connected to the first sub-frame and the second sub-frame, respectively, in order to support the load-bearing of the cushion area and to achieve the effect of reducing vibration, and at the same time to facilitate the installation of a mudguard by means of the fender mount.

Embodiments may also include a frame according to, characterized in that the second support bar may be made of hollow metal tubing in a curved or diagonal shape. Embodiments may also include a frame according to any one-17, characterized in that the frame may include oppositely disposed first cushion fixing bar and second cushion fixing bar, the first cushion fixing bar being transversely connected between the first main frame and the upper part of the second main frame and the second cushion fixing bar being transversely connected within the support frame, by means of which first cushion fixing bar and second cushion fixing bar may be used for mounting and positioning the cushion. Embodiments may also include a frame according to, characterized in that the length of the second cushion fixing bar may be greater than the length of first cushion fixing bar in order to make the mounted cushion, the dimensions of the rear end of which may be greater than the dimensions of the front end, ergonomically designed.

Embodiments of the present disclosure may also include a motorbike including frame, the frame including frame head tube, main frame assembly, sub-frame components, and support assembly. In some embodiments, the main frame assembly may include first main frame and second main frame disposed diagonally opposite each other, the first main frame and the second main frame both being of a bent structure and having their ends attached to the same side of the frame head tube and forming a closed loop with the frame head tube. The distance between the rear ends of the first main frame and the second main frame may be greater than the distance between the front ends so as to form a space for the installation of the engine between first main frame and second main frame.

In some embodiments, the sub-frame components may include oppositely disposed first sub-frame and second sub-frame, the first sub-frame and second sub-frame both being of a bent structure, and the first sub-frame being connected diagonally to a lower portion of the rear side of the first main frame at each end, and the second sub-frame being connected diagonally to a lower portion of the rear side of the second main frame at each front and rear end, so as to form a space for mounting the brake between first sub-frame and second sub-frame.

In some embodiments, the support assembly may include support frame, the support frame being of a bent structure, the ends of the support frame being attached diagonally from below to an upper portion of the rear side of the first main frame and the second main frame, respectively, so as to form a recessed area for mounting a cushion between the upper ends of first main frame and second main frame and the upper end of support frame. In some embodiments, the frame adopts the structure of tube and plate combination, which has the characteristics of simple structure, high strength and low vibration, reducing the cost of motorbike and low cost. Embodiments may also include a motorbike according to, characterized in that the motorbike may be an off-road two-wheeled motorbike.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a block diagram illustrating a frame, according to some embodiments of the present disclosure.

FIG. 2 is a block diagram further illustrating the frame from FIG. 1, according to some embodiments of the present disclosure.

FIG. 3 is a block diagram further illustrating the frame from FIG. 1, according to some embodiments of the present disclosure.

FIG. 4 is a block diagram further illustrating the frame from FIG. 1, according to some embodiments of the present disclosure.

FIG. 5 is a block diagram illustrating a motorbike, according to some embodiments of the present disclosure.

### DESCRIPTION OF EMBODIMENTS

In the following, the technical scheme in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

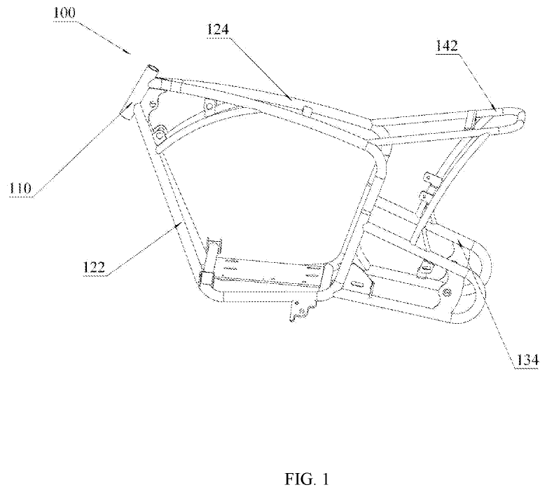

FIG. 1 is a block diagram that describes a frame 100, according to some embodiments of the present disclosure. In some embodiments, the frame 100 may include frame head tube 110, main frame assembly, sub-frame components, and support assembly. The main frame assembly may include first main frame 122. The main frame assembly may also include second main frame 124 disposed diagonally opposite each other, the first main frame 122 and the second main frame 124 both being of a bent structure. The second main frame 124 may include their ends attached to the same side of the frame head tube 110 and forming a closed loop with the frame head tube. The distance between the rear ends of the first main frame 122 and the second main frame 124 may be greater than the distance between the front ends so as to form a space for the installation of the engine between first main frame and second main frame.

In some embodiments, the sub-frame components may include oppositely disposed first sub-frame. The sub-frame components may also include second sub-frame 134, the first sub-frame and second sub-frame both being of a bent structure, and the first sub-frame being connected diagonally to a lower portion of the rear side of the first main frame at each end, and the second sub-frame being connected diagonally to a lower portion of the rear side of the second main frame at each front and rear end, so as to form a space for mounting the brake between first sub-frame and second sub-frame. The support assembly may also include support frame 142, the support frame being of a bent structure, the ends of the support frame 142 being attached diagonally from below to an upper portion of the rear side of the first main frame and the second main frame, respectively, so as to form a recessed area for mounting a cushion between the upper ends of first main frame and second main frame and the upper end of support frame.

In some embodiments, characterized in that the frame head tube 110 may be made of a hollow metal tubular member with steering limit seat mounted at the bottom to limit the steering angle of frame head tube. In some embodiments, the frame 100, characterized in that the first main frame and the second main frame may be made of hollow metal tubing, which may be low cost and easy to process, and both. The same shape and dimensions in a generally trapezoidal shape, with an arc at the upper end, which allows for the formation of a larger space for mounting the engine under a limited perimeter between the first main frame. The second main frame may include a smooth and beautiful profile.

In some embodiments, characterized in that the first main frame and the second main frame may also be rectangular, or triangular, or circular, or sector, or irregular polygonal. In some embodiments, the frame 100, characterized in that the first sub-frame and the second sub-frame may be made of hollow metal tubing, which may be low cost and easy to process, and both. The same shape and dimensions in a U-shape. In some embodiments, characterized in that the first sub-frame and the second sub-frame may also be semi-circular.

In some embodiments, characterized in that the first sub-frame and the second sub-frame may be further mounted on the inside of the brake mount and first decorative plate mount, by means of which the brake may be mounted and positioned, and by means of which first decorative plate mount facilitates the fixed mounting of a decorative plate. In some embodiments, characterized in that the support frame forms an angular connection between the first main frame and the second main frame, respectively, in an angular range of between 145-175°, which angular range may be the recessed area where the cushion may be mounted.

In some embodiments, characterized in that the support frame forms an angular connection between the first main frame and the second main frame, respectively, in an angular range of between 155-165°, which angular range may be the recessed area where the cushion may be mounted. In some embodiments, characterized in that the support frame may be made of hollow metal tubing in the shape of a U, which may be low cost and easy to process. In some embodiments, characterized in that the support frame may also be semi-circular.

In some embodiments, oppositely disposed first cushion fixing bar and second cushion fixing bar, the first cushion fixing bar being transversely connected between the first main frame and the upper part of the second main frame and the second cushion fixing bar being transversely connected within the support frame, by means of which first cushion fixing bar and second cushion fixing bar may be used for mounting and positioning the cushion. In some embodiments, characterized in that the length of the second cushion fixing bar may be greater than the length of first cushion fixing bar in order to make the mounted cushion, the dimensions of the rear end of which may be greater than the dimensions of the front end, ergonomically designed.

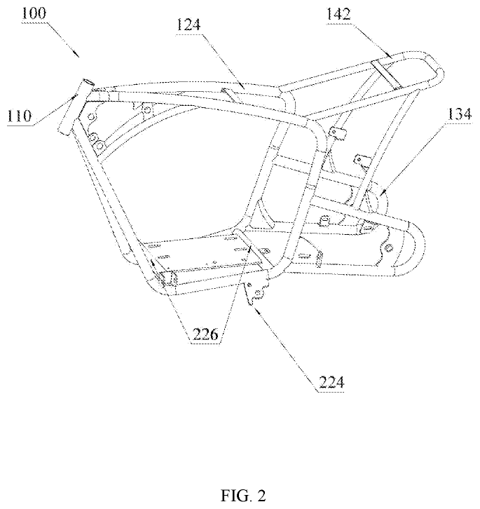

FIG. 2 is a block diagram that further describes the frame 100 from FIG. 1, according to some embodiments of the present disclosure. In some embodiments, the frame 224 may also include engine connecting tube, engine mounting plate 226 and footrest connecting tube, the engine connecting tube being connected between the rear end of the first main frame and the lower part of the second main frame, the footrest connecting tube being connected at the front end of the first main frame and the lower part of the second main frame and extending at both ends to the outside of the first main frame and the second main frame, respectively, and the engine mounting plate being connected between the engine connecting tube and the footrest connecting tube, with a welded fixing connection for a firm connection, by means of which the engine may be mounted and positioned, and by means of which the late may be used to mount the plate. In some embodiments, characterized in that the footrest connecting tube may be made of hollow metal tubing, each end of which may be connected to footrest mount in a slotted structure so as to allow the mounting of a footplate through footrest mount.

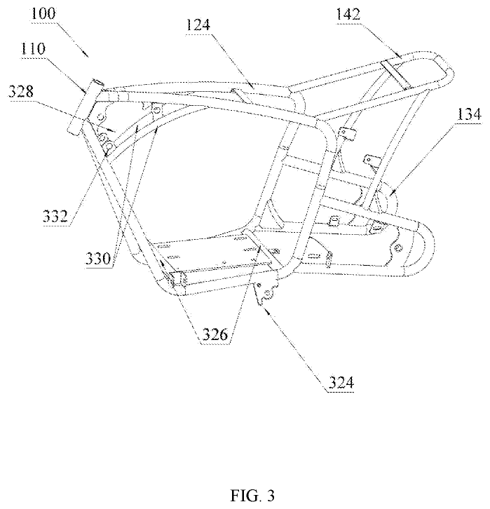

FIG. 3 is a block diagram that further describes the frame 100 from FIG. 1, according to some embodiments of the present disclosure. In some embodiments, the frame 324 may also include engine connecting tube, engine mounting plate 326 and footrest connecting tube, the engine connecting tube being connected between the rear end of the first main frame and the lower part of the second main frame, the footrest connecting tube being connected at the front end of the first main frame and the lower part of the second main frame and extending at both ends to the outside of the first main frame and the second main frame, respectively, and the engine mounting plate being connected between the engine connecting tube and the footrest connecting tube, with a welded fixing connection for a firm connection, by means of which the engine may be mounted and positioned, and by means of which the late may be used to mount the plate.

In some embodiments, the frame 328 may include two first support strips 330. The frame 328 may also include a second trim plate mount 332 mounted on the first support strips, the two first support strips being provided opposite to each other, and one end of the first support strips being connected to the inner top of the first main frame or the second main frame respectively, and the other end being connected to the inner side portion of the first main frame or the second main frame respectively, in order to increase the structural strength of the (first main frame and second main frame) and to achieve a reduction of vibration, and at the same time to facilitate the fixing and mounting of a decorative plate by means of the second trim plate mount 332. In some embodiments, characterized in that the first support strips may be made of hollow metal tubing in the form of a curved or diagonal shape.

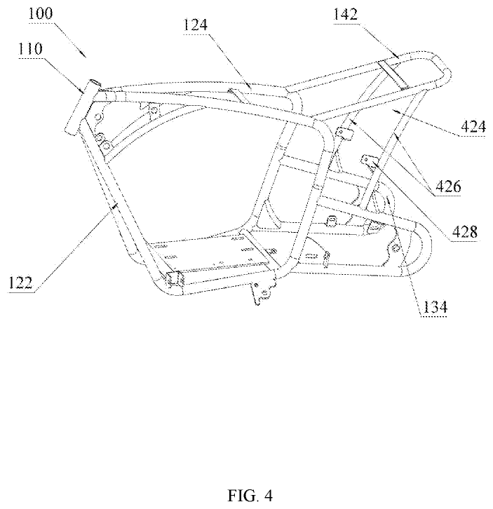

FIG. 4 is a block diagram that further describes the frame 100 from FIG. 1, according to some embodiments of the present disclosure. In some embodiments, the frame 424 may include two second support bar 426. The frame 424 may also include an fender mount 428 mounted on the second support bar 426, the two second support bar 426 being set opposite to each other, and one end of each of the second support bar 426 being connected to the support frame, and the other end being connected to the first sub-frame and the second sub-frame, respectively, in order to support the load-bearing of the cushion area and to achieve the effect of reducing vibration, and at the same time to facilitate the installation of a mudguard by means of the fender mount 428. In some embodiments, characterized in that the second support bar 426 may be made of hollow metal tubing in a curved or diagonal shape.

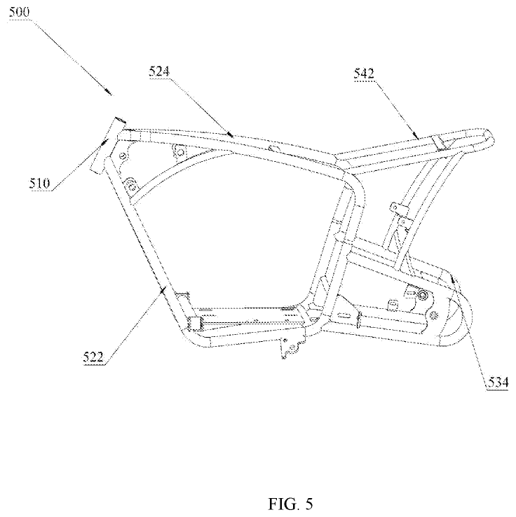

FIG. 5 is a block diagram that describes a motorbike 500, according to some embodiments of the present disclosure. In some embodiments, the motorbike 500 may include frame head tube 510, main frame assembly, sub-frame components, and support assembly, frame, the frame. The main frame assembly may include first main frame 522. The main frame assembly may also include second main frame 524 disposed diagonally opposite each other, the first main frame 522 and the second main frame 524 both being of a bent structure. The second main frame 524 may include their ends attached to the same side of the frame head tube 510 and forming a closed loop with the frame head tube. The distance between the rear ends of the first main frame 522 and the second main frame 524 may be greater than the distance between the front ends so as to form a space for the installation of the engine between first main frame and second main frame.

In some embodiments, the sub-frame components may include oppositely disposed first sub-frame. The sub-frame components may also include second sub-frame 534, the first sub-frame and second sub-frame both being of a bent structure, and the first sub-frame being connected diagonally to a lower portion of the rear side of the first main frame at each end, and the second sub-frame being connected diagonally to a lower portion of the rear side of the second main frame at each front and rear end, so as to form a space for mounting the brake between first sub-frame and second sub-frame.

In some embodiments, the support assembly may also include support frame 542, the support frame being of a bent structure, the ends of the support frame 542 being attached diagonally from below to an upper portion of the rear side of the first main frame and the second main frame, respectively, so as to form a recessed area for mounting a cushion between the upper ends of first main frame and second main frame and the upper end of support frame. The frame adopts the structure of tube and plate combination, which. The characteristics of simple structure, high strength and low vibration, reducing the cost of motorbike and low cost. In some embodiments, characterized in that the motorbike may be an off-road two-wheeled motorbike.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

1. A kind of motorbike frame characterized in that it comprises frame head tube, main frame assembly, sub-frame components, and support assembly;
Said main frame assembly comprises first main frame and second main frame disposed diagonally opposite each other, said first main frame and said second main frame both being of a bent structure and having their ends attached to the same side of said frame head tube and forming a closed loop with said frame head tube. The distance between the rear ends of said first main frame and said second main frame is greater than the distance between the front ends so as to form a space for the installation of the engine between first main frame and second main frame;
Said sub-frame components comprises oppositely disposed first sub-frame and second sub-frame, said first sub-frame and second sub-frame both being of a bent structure, and said first sub-frame being connected diagonally to a lower portion of the rear side of said first main frame at each end, and said second sub-frame being connected diagonally to a lower portion of the rear side of said second main frame at each front and rear end, so as to form a space for mounting the brake between first sub-frame and second sub-frame;
Said support assembly comprises support frame, said support frame being of a bent structure, said ends of said support frame being attached diagonally from below to an upper portion of the rear side of said first main frame and said second main frame, respectively, so as to form a recessed area for mounting a cushion between the upper ends of first main frame and second main frame and the upper end of support frame.

2. A kind of motorbike frame according to claim 1, characterized in that said frame head tube is made of a hollow metal tubular member with frame head tube 1 mounted at the bottom to limit the steering angle of frame head tube.

3. A kind of motorbike frame according to claim 1, characterized in that said first main frame and said second main frame are made of hollow metal tubing, which is low cost and easy to process, and both have the same shape and dimensions in a generally trapezoidal shape, with an arc at the upper end, which allows for the formation of a larger space for mounting the engine under a limited perimeter between said first main frame and said second main frame, and has a smooth and beautiful profile.

4. A kind of motorbike frame according to claim 3, characterized in that said first main frame and said second main frame may also be rectangular, or triangular, or circular, or sector, or irregular polygonal.

5. A kind of motorbike frame according to claim 1, characterized in that said first sub-frame and said second sub-frame are made of hollow metal tubing, which is low cost and easy to process, and both have the same shape and dimensions in a U-shape.

6. A kind of motorbike frame according to claim 5, characterized in that said first sub-frame and said second sub-frame may also be semi-circular.

7. A kind of motorbike frame according to claim 6, characterized in that said first sub-frame and said second sub-frame are further mounted on the inside of said brake mount and brake mount, by means of which the brake is mounted and positioned, and by means of which brake mount facilitates the fixed mounting of a decorative plate.

8. A kind of motorbike frame according to claim 1, characterized in that said support frame forms an angular connection between said first main frame and said second main frame, respectively, in an angular range of between 145-175°, which angular range is the recessed area where the cushion is mounted.

9. A kind of motorbike frame according to claim 8, characterized in that said support frame forms an angular connection between said first main frame and said second main frame, respectively, in an angular range of between 155-165°, which angular range is the recessed area where the cushion is mounted.

10. A kind of motorbike frame according to claim 8, characterized in that said support frame is made of hollow metal tubing in the shape of a U, which is low cost and easy to process.

11. A kind of motorbike frame according to claim 10, characterized in that said support frame may also be semi-circular.

12. A kind of motorbike frame according to claim 1, characterized in that said main frame assembly further comprises engine connecting tube, engine mounting plate and footrest connecting tube, said engine connecting tube being connected between the rear end of said first main frame and said lower part of said second main frame, said footrest connecting tube being connected at the front end of said first main frame and said lower part of said second main frame and extending at both ends to the outside of said first main frame and said second main frame, respectively, and said engine mounting plate being connected between said engine connecting tube and said footrest connecting tube, with a welded fixing connection for a firm connection, by means of which the engine is mounted and positioned, and by means of which the late is used to mount the plate.

13. A kind of motorbike frame according to claim 12, characterized in that said footrest connecting tube is made of hollow metal tubing, each end of which is connected to footrest mount in a slotted structure so as to allow the mounting of a footplate through footrest mount.

14. A kind of motorbike frame according to claim 12, characterized in that said main frame assembly further comprises two first support strips and a second trim plate mount mounted on said first support strips, the two first support strips being provided opposite to each other, and one end of said first support strips being connected to the inner top of said first main frame or said second main frame respectively, and the other end being connected to the inner side portion of said first main frame or said second main frame respectively, in order to increase the structural strength of the (first main frame and second main frame) and to achieve a reduction of vibration, and at the same time to facilitate the fixing and mounting of a decorative plate by means of the second trim plate mount.

15. A kind of motorbike frame according to claim 14, characterized in that said first support strips is made of hollow metal tubing in the form of a curved or diagonal shape.

16. A kind of motorbike frame according to claim 1, characterized in that said support assembly further comprises two support frame and an second support bar mounted on said support frame, the two support frame being set opposite to each other, and one end of each of said support frame being connected to said support frame, and the other end being connected to said first sub-frame and said second sub-frame, respectively, in order to support the load-bearing of the cushion area and to achieve the effect of reducing vibration, and at the same time to facilitate the installation of a mudguard by means of the second support bar.

17. A kind of motorbike frame according to claim 16, characterized in that said support frame is made of hollow metal tubing in a curved or diagonal shape.

18. A kind of motorbike frame according to claim 17, characterized in that said frame further comprises oppositely disposed first cushion fixing bar and second cushion fixing bar, said first cushion fixing bar being transversely connected between said first main frame and said upper part of said second main frame and said second cushion fixing bar being transversely connected within said support frame, by means of which first cushion fixing bar and second cushion fixing bar are used for mounting and positioning the cushion.

19. A kind of motorbike frame according to claim 18, characterized in that the length of said second cushion fixing bar is greater than the length of first cushion fixing bar in order to make the mounted cushion, the dimensions of the rear end of which are greater than the dimensions of the front end, ergonomically designed.

20. A motorbike comprising frame, said frame comprising frame head tube, main frame assembly, sub-frame components, and support assembly;
Said main frame assembly comprises first main frame and second main frame disposed diagonally opposite each other, said first main frame and said second main frame both being of a bent structure and having their ends attached to the same side of said frame head tube and forming a closed loop with said frame head tube. The distance between the rear ends of said first main frame and said second main frame is greater than the distance between the front ends so as to form a space for the installation of the engine between first main frame and second main frame;
Said sub-frame components comprises oppositely disposed first sub-frame and second sub-frame, said first sub-frame and second sub-frame both being of a bent structure, and said first sub-frame being connected diagonally to a lower portion of the rear side of said first main frame at each end, and said second sub-frame being connected diagonally to a lower portion of the rear side of said second main frame at each front and rear end, so as to form a space for mounting the brake between first sub-frame and second sub-frame;
Said support assembly comprises support frame, said support frame being of a bent structure, said ends of said support frame being attached diagonally from below to an upper portion of the rear side of said first main frame and said second main frame, respectively, so as to form a recessed area for mounting a cushion between the upper ends of first main frame and second main frame and the upper end of support frame;
The frame adopts the structure of tube and plate combination, which has the characteristics of simple structure, high strength and low vibration, reducing the cost of motorbike and low cost.
